(19) United States
(12) Patent Application Publication
(10) Pub. No.: US 2006/0157665 A1
(43) Pub. Date: Jul. 20, 2006

(54) Modulator valve assembly

(76) Inventor: Mark Geoffrey Masen, Royal Oak, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/315,875

(22) Filed: Dec. 22, 2005

Related U.S. Application Data
(60) Provisional application No. 60/638,501, filed on Dec. 22, 2004.

(51) Int. Cl. F16K 31/00

(52) U.S. Cl. 251/339

(57) ABSTRACT

A modulator valve assembly (10) includes a valve seat (32) assembled as part of a housing (12), and the valve seat (32) defines inlet and outlet ports to allow fluid to flow between an inlet passage (28) and an outlet passage (30) along a fluid flow path. The modulator valve assembly (10) also includes a movable valve member (62) that is threaded to a rod (56) that extends through the valve seat (32), and as the rod (56) rotates, the movable valve member (62) moves axially along the rod (56). A pin (72) extends from the housing (12) to engage the movable valve member (62) to prevent the movable valve member (62) from rotating with the rod (56). The movable valve member (62) slides along the rod (56) into the fluid flow path and blocks the fluid from entering the housing (12).

### RELATED APPLICATIONS

This application claims the benefit of U.S. Provisional Patent Application Ser. No. 60/638,501 filed Dec. 22, 2004, the advantages and disclosure of which are hereby incorporated by reference.

### BACKGROUND OF THE INVENTION

1. Field of the Invention

The subject invention relates to a modulator valve assembly for regulating fluid flow a long a fluid flow path.

2. Description of the Prior Art

Various modulator valve assemblies are known in the prior art. The modulator valves of the prior art disclose a housing defining an inlet passage and an outlet passage with a motor supported on the housing. A shaft extends from the motor into the housing and is coupled to a rod. A movable valve member disposed about the rod and threads interconnect the rod and the movable valve member. As the motor rotates the shaft, the movable valve member of the prior art modulator valve assemblies moves axially with the rod.

Although the modulator valve assemblies of the prior art are enjoyed in various industries, there remains an opportunity for a modulator valve assembly that has a reduced number of parts, has a reduced size, and provides more control in regulating fluid flow.

### SUMMARY OF THE INVENTION AND ADVANTAGES

The invention provides for a modulator valve assembly including a housing that defines an inlet passage that extends into an inlet wall for fluid to enter into the housing and an outlet passage that extends into an outlet wall for fluid to exit the housing. The housing includes a valve seat disposed between the inlet and outlet passages, and a rod extends through the valve seat. A movable valve member is disposed about the rod, and threads interconnect the movable valve member to the rod. The modulator valve assembly further includes a pin that extends from the housing into a complimentary bore formed in the movable valve member.

The invention also provides a modulator valve assembly that includes a housing that defines an inlet passage that extends into an inlet wall for fluid to enter the housing, an outlet passage axially aligned with the inlet passage, and the outlet passage extends into an outlet wall for fluid to exit the housing. The housing includes a conical valve seat surface between the passages. The inlet and outlet passages define radial valve ports in the conical valve seat. A rod extends through the valve seat surface, and a movable valve member is disposed about the rod. Threads interconnect the rod and the movable valve member.

Accordingly, the subject invention provides a modulator valve assembly that has several advantages over the prior art. First, the modulator valve assembly of the subject invention uses fewer parts than previous modulator valve assemblies do. In addition, the subject invention provides a modulator valve assembly that has increased precision and regulation of fluid flow. Although not specified, other advantages of the modulator valve assembly may be realized.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a plan view of a modulator valve assembly assembled in accordance with the subject invention;

FIG. 2 is a cross-section of the modulator valve assembly of FIG. 1 along axis 2-2;

FIG. 3 is a cross-section of the modulator valve assembly of FIG. 1 along axis 3-3;

FIG. 4 is a top view of an inside of a housing of the modulator valve assembly of FIG. 1; and

FIG. 5 is a bottom view of the inside of the housing of the modulator valve assembly of FIG. 1.

### DETAILED DESCRIPTION OF THE INVENTION

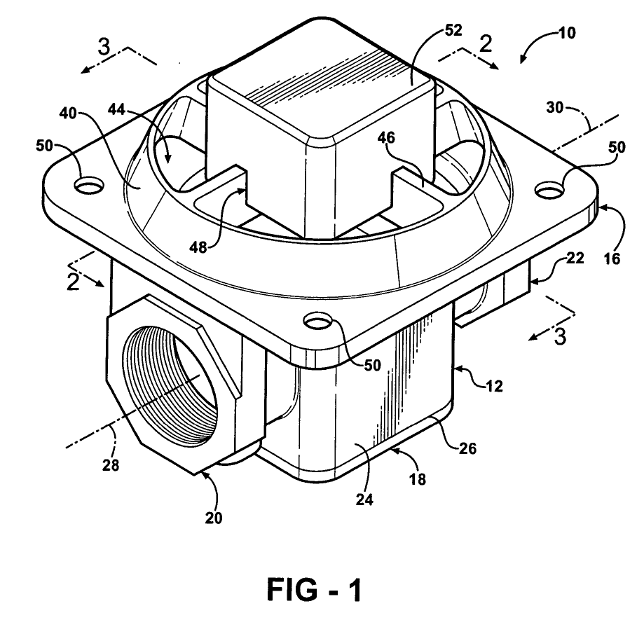

Referring to the Figures, wherein like numerals indicate corresponding parts throughout the several views, a modulator valve assembly is shown generally at 10. Referring now to FIGS. 1-3, the modulator valve assembly 10 includes a housing 12 that has a four sided cross-section disposed about a central axis 14 extending between a top portion 16 and a bottom portion 18 to define oppositely disposed inlet and outlet walls 20, 22 interconnected by side walls 24. The bottom portion 18 of the housing 12 is connected to the housing 12 with a fastener. A gasket 26 may be placed between the bottom portion 18 of the housing 12 and the side walls 24 to prevent fluid from leaking through the bottom portion 18. The housing 12 defines an inlet passage 28 that extends into the inlet wall 20 to allow fluid to enter into the housing 12, and defines an outlet passage 30 that extends into the outlet wall 22 to allow fluid to exit the housing 12. It may be preferred that the inlet passage 28 is axially aligned with the outlet passage 30.

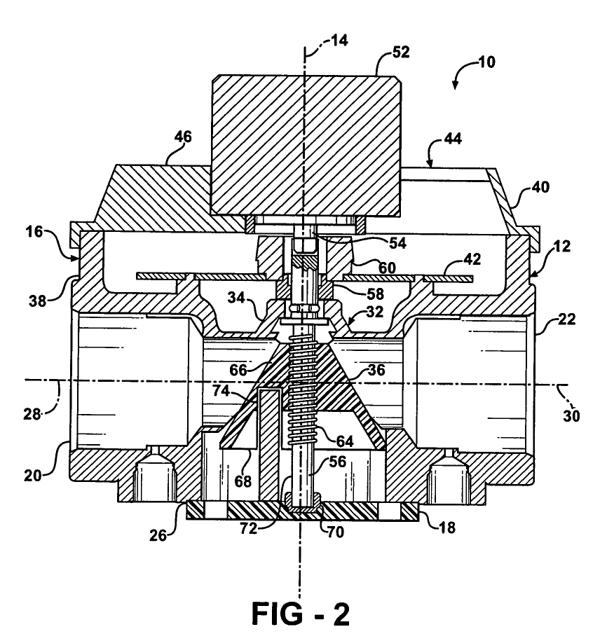

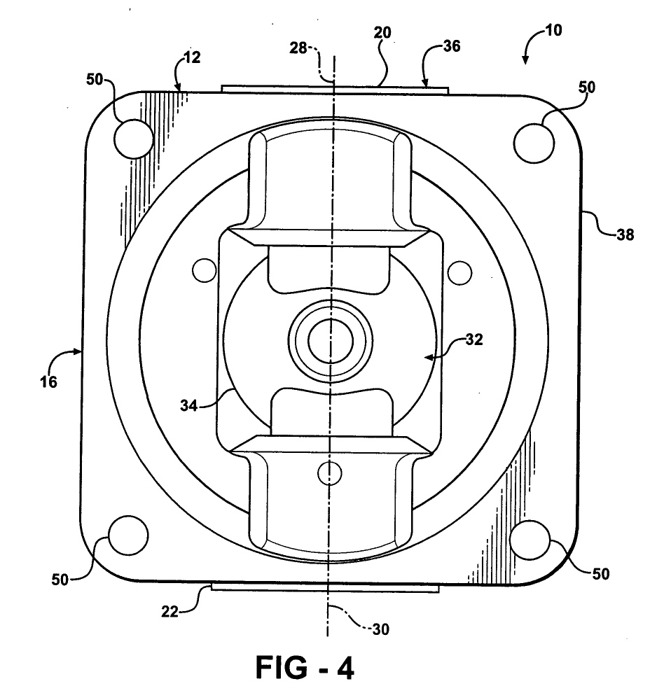

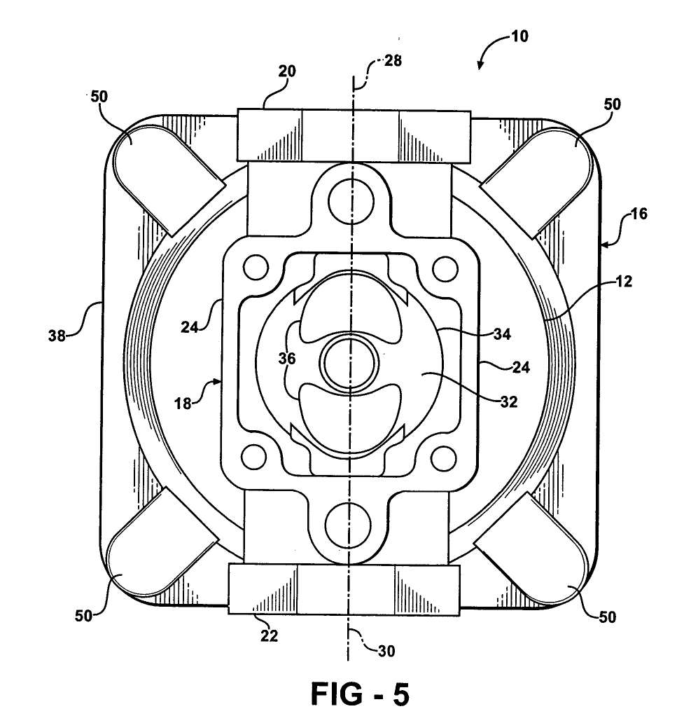

Referring now to FIGS. 2-5, the housing 12 further includes a valve seat 32 that has a valve seat surface 34. Various shapes may be used for the valve seat 32, and as shown in the figures, the valve seat 32 may be conical. The valve seat 32 is disposed about the central axis 14 and is transverse to the passages 28, 30. The passages 28, 30 define valve ports 36 in the conical valve seat surface 34. FIG. 4 shows the inside of the housing 12 from a top view, and FIG. 5 shows the inside of the housing 12 from a bottom view with the bottom portion 18 removed.

Referring now to FIGS. 1-4, a flange 38 may be used to support 40 various objects on the housing 12. The flange 38 may extend radially and outwardly about the top portion 16 of the housing 12. One object supported on the flange 38 may be a circuit board 42. The circuit board 42 may be supported on the flange 38 perpendicular to the central axis 14 in order to provide electrical control to various components used to control the modulator valve assembly 10. A support 40 may be disposed on and extending upwardly from the flange 38 to an opening 44, and may include transverse webs 46 extending across the opening 44 that define a pocket 48. The support 40 may be attached to the housing 12 using any type of fastener known in the art. For example, as shown in FIGS. 1, 4, and 5, the top portion 16 includes holes 50. A fastener, such as a screw, can be put into the holes 50 to secure the support 40 to the flange 38.

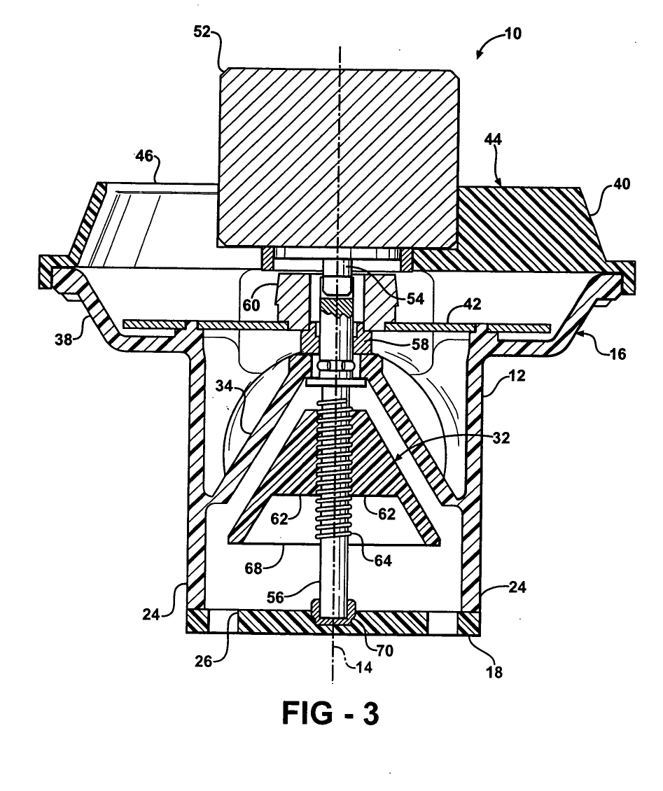

Referring back to FIGS. 1-3, a motor 52 may be disposed in the opening 44 and supported in the pocket 48 of the webs 46. Also, the motor 52 may be electrically connected to the circuit board 42 in order for the circuit board 42 to control the motor 52. The motor 52 may include a shaft 54 that extends into the opening 44 along the central axis 14, and a rod 56 coupled to the shaft 54 may extend along the central axis 14 through the circuit board 42 and through the valve seat 32 to a distal end of the housing 12. As shown in FIGS. 2 and 3, a seal 58 may be disposed about the rod 56 and the seal 58 may extend along the rod 56 between the valve seat 32 and the circuit board 42. The seal 58 helps prevent the fluid from flowing between the rod 56 and the circuit board 42. In addition, a rod sensor 60 may be mounted on the circuit board 42 about the rod 56 for determining rotational movement of the rod 56. Various types of sensors may be used, such as a shaft encoder. Likewise, a shaft sensor may be mounted to the shaft 54 of the motor 52 and electrically connected to the circuit board 42 for determining rotational movement of the shaft 54 of the motor 52. The shaft sensor may also be any type of sensor known in the art, such as a shaft encoder.

A movable valve member 62 may be disposed about the rod 56. Threads 64 are used to interconnect the rod 56 and the movable valve member 62. The rod 56 allows the movable valve member 62 to move axially into engagement with the valve seat 32 in response to rotation of the rod 56 by the motor 52 to close the valve ports 36 in the valve seat 32 for controlling fluid flow from the inlet passage 28 to the outlet passage 30. The movable valve member 62 may have a conical shape with a solid top 66 and a skirt 68 at the bottom, although other shapes may be preferred. For example, the movable valve member 62 can be any shape that can engage the valve seat 32 to prevent fluid from flowing along the fluid flow path when the movable valve member 62 moves into engagement with the valve seat 32. Also, the movable valve member 62 can be made of any material that can withstand lengthy exposure to fuel gases. A bushing 70 is supported in the bottom portion 18 of the housing 12 for rotatably supporting the distal end of the rod 56 to prevent radial movement of the rod 56.

Referring back to FIG. 2, a pin 72 may extend from the bottom portion 18 of the housing 12 into sliding engagement with a complimentary bore 74 defined by the movable valve member 62 to prevent the movable valve member 62 from rotating with the rod 56 as the motor 52 rotates the rod 56 and moves the movable valve member 62 axially along the rod 56. The pin 72 may be laterally spaced from the bushing 70, and multiple pins may be used, as well as pins of various heights and widths. Likewise, the movable valve member 62 may include multiple bores 74 to accommodate more than one pin 72.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility.

1. A modulator valve assembly comprising;
a housing defining an inlet passage extending into an inlet wall for fluid to enter into said housing and defining an outlet passage extending into an outlet wall for fluid to exit said housing,
said housing including a valve seat disposed between said passages,
a rod extending through said valve seat,
a movable valve member having a conical shape and disposed about said rod,
threads threadedly interconnecting said rod and said movable valve member for moving said movable valve member axially into engagement with said valve seat in response to rotation of said rod for controlling fluid flow from said inlet passage to said outlet passage, and
characterized by a pin extending from said bottom portion of said housing into sliding engagement with a complimentary bore extending into said movable valve member for preventing said movable valve member from rotating with said rod as said movable valve member moves axially along said rod.

2. The modulator valve assembly of claim 1 further comprising said movable valve member having a solid top and a skirt below said solid top.

3. The modulator valve assembly of claim 2 further comprising said bore extending into said solid top of said movable valve member.

4. The modulator valve assembly of claim 1 further comprising a bushing supported in said housing for rotatably supporting said rod for preventing radial movement of said rod.

5. The modulator valve assembly of claim 4 further comprising said pin being laterally spaced from said bushing inside said housing.

6. A modulator valve assembly comprising;
a housing defining an inlet passage extending into an inlet wall for fluid to enter into said housing and an outlet passage extending into an outlet wall for fluid to exit said housing,
said inlet passage being axially aligned with said outlet passage,
said housing including a conical valve seat surface between said passages with said passages defining radial valve ports in said conical valve seat surface,
a rod extending through said valve seat surface,
a movable valve member disposed about said rod, and
threads threadedly interconnecting said rod and said movable valve member for moving said movable valve member axially into engagement with said valve seat in response to rotation of said rod to cover said valve ports in said valve seat surface for controlling fluid flow from said inlet passage to said outlet passage.

7. The modulator valve assembly of claim 6 further comprising a lost motion connection between said housing and said movable valve member for preventing said movable valve member from rotating with said rod as said movable valve member moves axially along said rod.

8. The modulator valve assembly of claim 7 further comprising said lost motion connection having a pin extending from said housing into a bore extending into said movable valve member.

9. The modulator valve assembly of claim 6 further comprising said housing having a four sided cross-section disposed about a central axis extending between a top portion and a bottom portion to define said inlet and outlet walls interconnected by side walls.

10. The modulator valve assembly of claim 9 further comprising a bushing supported in said bottom portion of said housing for rotatably supporting said rod and preventing lateral movement of said rod.

11. The modulator valve assembly of claim 6 further comprising a flange extending radially outwardly about said housing.

12. The modulator valve assembly of claim 11 further comprising a support disposed on said flange and extending to an opening.

13. The modulator valve assembly of claim 12 further comprising said support including transverse webs extending across said opening and defining a pocket.

14. The modulator valve assembly of claim 13 further comprising a motor disposed in said opening and supported in said pocket of said webs of said support.

15. The modulator valve assembly of claim 14 further comprising a shaft extending from said motor into said opening and coupled to said rod.

16. The modulator valve assembly of claim 14 further comprising a circuit board supported on said flange.

17. The modulator valve assembly of claim 16 further comprising said motor electrically connected to said circuit board.

18. The modulator valve assembly of claim 16 further comprising said rod extending through said circuit board.

19. The modulator valve assembly of claim 18 further comprising a seal disposed about said rod and extending along said rod from said valve seat surface to said circuit board for preventing fluid from flowing between said rod and said circuit board.

20. The modulator valve assembly of claim 18 further comprising a rod sensor mounted on said circuit board about said rod for determining rotational movement of said rod.
